(19) United States
(12) Patent Application Publication
(10) Pub. No.: US 2015/0045496 A1
(43) Pub. Date: Feb. 12, 2015

(54) THERMO-REVERSIBLE POLYBUTADIENE RUBBER BLEND WITH SELF-HEALING NATURE

(71) Applicant: Reliance Industries Limited, Maharashtra (IN)

(72) Inventors: Rakshvir Jasra, Mumbai (IN); Madhuchhanda Maiti, Mumbai (IN); Vivek Srivastava, Mumbai (IN)

(21) Appl. No.: 14/385,074

(22) PCT Filed: Mar. 14, 2013
(86) PCT No.: PCT/IN2013/000157

§ 371 Date: Sep. 12, 2014

(30) Foreign Application Priority Data
Mar. 14, 2012 (IN) 362/MUM/2012

(51) Int. Cl. C08L 47/00

(52) U.S. Cl. CPC C08L 47/00
USPC 524/525; 525/232; 525/197

(57) ABSTRACT

The present disclosure relates to a thermo-reversible and self-healing blend comprising polybutadiene compounded with at least one ring opening agent and at least one ring compound containing at least one hetero-cyclic compound and at least one grafting enabling moiety, wherein the ring opening agent is capable of opening the ring compound to provide at least one open functional group to which the ring opening agent is capable of bonding, and wherein the ring compound is capable of grafting on the backbone of a polymer through the grafting enabling moiety. The present disclosure also relates to a process for preparing a thermo-reversible and self-healing blend and its use in preparing molded articles.

### FIELD OF THE DISCLOSURE

The present disclosure relates to an elastic material. Particularly, the present disclosure relates to synthetic rubber.

### BACKGROUND

Polybutadiene rubber (BR) is the second most important synthetic general-purpose rubber produced worldwide. The global consumption of Polybutadiene rubber is approximately around 2.8 million metric tons per year, and it is forecasted that the average global consumption of Polybutadiene rubber may increase at the rate of around. 4.0% per year. Polybutadiene rubber is a homopolymer produced by polymerization of 1,3-butadiene (BD). Polybutadiene rubber finds major application in manufacturing of tyres where it is blended with other elastomers and crosslinked with the sulfur vulcanization system. Generally, the conventionally vulcanized Polybutadiene rubber has the following composition:

| Ingredients | Phr (parts per hundred parts of rubber) |
|---|---|
| BR | 100 |
| ZnO | 3 |
| Stearic acid | 1.5 |
| CBS | 0.8 |
| Sulfur | 2.0 |

After its product life, these are mostly used as thermal energy sources, as these compounds are not recyclable. The inability to recycle rubber products made of Polybutadiene rubber is attributed to the semi-permanent cross-linking systems such as sulfur vulcanization which restricts its reuse as a raw material. The bond energy of covalent sulfur crosslinking is too high to recycle it in usual rubber processing conditions. FIG. 1a of the accompanying drawings illustrates the sulfur crosslinking between the Polybutadiene rubber chains.

Accordingly, recycling of rubber products made of Polybutadiene rubber is uneconomical, infeasible and therefore not recommended. Moreover, due to continuous flexing in the products like tyre, some micro-cracks are generated in the product, thereby substantially reducing the operational life of the tyrds. Due to the limitation associated with the recycling of the tyres made of conventionally vulcanized Polybutadiene rubber, researchers are in search of thermo-reversibly crosslinked rubber as well as self-healing rubbers. Thermo-reversibly crosslinked rubber can provide the recyclability to typical rubber products and self-healing nature can enhance the product life significantly. There are a few reports on thermo-reversibly crosslinked elastomers of commercial grade e.g. polyisoprene or natural rubber, Ethylene/Propylene copolymers and butyl rubber via melt-mixing and solution methods. In all these works, maleic anhydride (MAH) is grafted directly onto the polymer backbone to produce maleated-polymers which is difficult for commercial grade of BR. Thereafter, the maleic anhydride ring is opened using various amines to generate thermo-reversibility through H-bonding between the polymer backbones. However, Peng et al. modified commercial BR in solution method by three steps polymer analogous reaction e.g. epoxidation, oxirane ring-opening, and sulfonyl isocyanate addition. After these modifications, modified polymer behaved as a thermoplastic elastomer. However, most of the conventional methods for imparting self healing properties to the rubber are in-effective and expensive.

Accordingly, there is a need to develop a thermo-reversibly crosslinked rubber that can be economically recycled. Further, there is a need to develop synthetic rubber that exhibits self-healing properties, thereby significantly enhancing the life of the products configured there-from. Further, there is a need for a synthetic rubber that can be economically and conveniently manufactured.

### DEFINITIONS

As used in the present disclosure, the following words and phrases are generally intended to have the meaning as set forth below, except to the extent that the context in which they are used to indicate otherwise.

The expression ‘grafting’ indicates surface to surface adhesion of one molecule to another, wherein the molecule includes but is not limited to polymer, ring compound containing at least one hetero atom and ring opening agent.

The expression ‘backbone of a polymer’ includes a backbone chain or a main chain of a polymer comprising a series of covalently bonded atoms that together create a continuous chain of the molecule. Further, the backbone of a polymer is such that it provides support to any attached molecule.

### OBJECTS

Some of the objects of the present disclosure which at least one embodiment herein satisfies are as follows:

It is an object of the present disclosure to ameliorate one or more problems of the prior art or to at least provide a useful alternative.

It is another object of the present disclosure to provide a polybutadiene rubber blend which possesses thermo-reversible and self-healing properties, improved mechanical properties, improved operational life and wear resistant properties.

It is yet another object of the present disclosure to provide a polybutadiene rubber blend which can with-stand tough operational conditions.

It is still a further object of the present disclosure to provide a process for preparing a polybutadiene rubber blend.

It is still another object of the present disclosure to provide a polybutadiene rubber blend that enhances quality and performance of the products configured there-from.

It is still further object of the present disclosure to provide a simple and economic process for preparing a polybutadiene rubber blend.

Other objects and advantages of the present disclosure will be more apparent from the following description when read in conjunction with the accompanying figures, which are not intended to limit the scope of the present disclosure.

In one aspect of the present disclosure there is provided a thermo-reversible and self-healing blend comprising polybutadiene compounded with at least one ring opening agent and at least one ring compound containing at least one hetero-cyclic compound and at least one grafting enabling moiety, wherein the ring opening agent is capable of opening the ring compound to provide at least one open functional group to which the ring opening agent is capable of bonding, and wherein the ring compound is capable of grafting on the backbone of a polymer through the grafting enabling moiety.

Typically, the grafting enabling moiety is an olefinic bond.

Typically, the open functional group is bonded to the ring opening agent through at least one linkage selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction and anion-pi interaction.

Preferably, the open functional group is bonded to the ring opening agent through at least one covalent bond.

Typically, the open functional groups are capable of bonding to each other through at least one linkage selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction and anion-pi interaction.

Typically, the ring compound contains at least one hetero-cyclic compound and at least one grafting enabling moiety is at least one compound selected from the group consisting of anhydrides, imides, thioanhydrides, lactones, lactams, thiolactones and epoxides.

Typically, the ring compound contains at least one hetero-cyclic compound and at least one grafting enabling moiety is at least one compound selected from the group consisting of Maleic anhydride, 2H-Pyran-2,6(3H)-dione, 2[5H]-furanone, furanone, 5,6-Dihydro-2H-pyran-2-one, 3,6-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one, preferably Maleic anhydride.

Typically, the blend comprises a polymer on which the ring compound is capable of being grafted, said polymer is at least one compound selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylomtrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

Typically, the ring compound is grafted on at least one polymer selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl, cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

Typically, the ring opening agent is at least one selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine, preferably 3-amino-1,2,4-triazole.

Typically, the proportion of the polybutadiene to polymer ranges between 4:1 and 20:1.

Typically, the proportion of the polybutadiene to the ring compound containing at least one hetero-cyclic compound and at least one grafting enabling moiety ranges between 5:1 and 25:1.

Typically, the proportion of the polybutadiene to the ring opening agent ranges between 5:1 and 25:1.

Typically, the proportion of the ring compound containing at least one hetero-cyclic compound and at least one grafting enabling moiety to the ring opening agent ranges between 1:1 and 3:1.

Typically, the proportion of the polymer to the ring opening agent ranges between 0.3:1 and 2:1.

Typically, the proportion of the polymer grafted on at least one ring compound containing at least one hetero-cyclic compound and at least one grafting enabling moiety to the ring opening agent ranges between 1:10 and 10:1

In one embodiment of the present disclosure the blend further comprises at least one filler selected from the group consisting of carbon black, silica and nanoclay.

In another embodiment of the present disclosure the blend further comprising at least one rubber selected from the group consisting of natural rubber, styrene-butadiene rubber, polybutadiene, cis-1,4-polyisoprenes acrylonitrile-butadiene copolymers EPDM rubber, butyl rubber and polychloroprene rubber.

Typically, the tensile strength of the blend ranges between 0.1 MPa and 1.0 MPa.

In accordance with another aspect of the present disclosure there is provided a process for preparing a thermo-reversible and self-healing blend comprising polybutadiene compounded with at least one ring opening agent and at least one ring compound containing at least one hetero-cyclic compound and at least one grafting enabling moiety, said process comprising the following steps:
a. melt mixing polybutadiene and at least one, ring compound containing at least one hetero-cyclic compound and at least one grafting enabling moiety grafted on at least one position of the backbone of a polymer to obtain a grafted mixture; and
b. adding at least one ring opening agent to the grafted mixture to obtain a blend, wherein the ring opening agent opens the ring compound to provide at least one open functional group of the ring compound to which the ring opening agent gets bonded.

Typically, the grafting enabling moiety is an olefinic bond.

Typically, the open functional group is bonded to the ring opening agent through at least one linkage selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction and anion-pi interaction.

Typically, the open functional group is bonded to the ring opening agent through at least one covalent bond.

Typically, the open functional groups are capable of bonding to each other through at least one linkage selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction and anion-pi interaction.

Typically, the ring compound containing at least one hetero-cyclic compound and at least one grafting enabling moiety is at least one compound selected from the group consisting of anhydrides, imides, thioanhydrides, lactones, lactams, thiolactones and epoxides.

Typically, the ring compound containing at least one hetero-cyclic compound and at least one grafting enabling moiety is at least one compound selected from the group consisting of Maleic anhydride, 2H-Pyran-2,6(3H)-dione, 2[5H]-furanone, furanone, 5,6-Dihydro-2H-pyran-2-one, 3,6-dihydro-2H-Pyran-2-one, 1H-pyrrol-2(5H)-one, 1-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one, preferably Maleic anhydride.

Typically, the blend comprises a polymer on which the ring compound is capable of being grafted, said polymer is at least one compound selected from the group consisting of Polybutadiene, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone. (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

Typically, the ring compound is grafted on at least one polymer selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCI), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol (PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

Typically, the ring opening agent is at least one selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine, preferably 3-amino-1,2,4-triazole.

Typically, the proportion of the polybutadiene to the polymer ranges between 4:1 and 20:1.

Typically, the proportion of the polybutadiene to the ring compound containing at least one hetero-cyclic compound and at least one grafting enabling moiety ranges between 5:1 and 25:1.

Typically, the proportion of the polybutadiene to the ring opening agent ranges between 5:1 and 25:1

Typically, the proportion of the ring compound containing at least one hetero-cyclic compound and at least one grafting enabling moiety to the ring opening agent ranges between 1:1.and 3:1.

Typically, the proportion of the polymer to the ring opening agent ranges between 0.3:1 and 2:1.

Typically, the proportion of the polymer grafted on at least one ring compound containing at least one hetero-cyclic compound the grafting enabling moiety to the ring opening agent ranges between 1:10 and 10:1.

Typically, the method step of melt mixing is carried out at a temperature of 165° C. to 195° C. with stirring at a speed ranging between 30 rpm and 60 rpm for a time period ranging between 0.5 hrs and 2.0 hrs.

Typically, the method step of adding is carried out at a temperature ranging between 165° C. and 195° C. with stirring at a speed ranging between 30 rpm and 60 rpm for a time period ranging between 0.5 hrs and 5.0 hrs to obtain a blend.

In one embodiment of the present disclosure the process further comprises a step of incorporating at least one filler selected from the group consisting of carbon black and silica and nanoclay in step (i) or (ii) or both.

In another embodiment of the present disclosure the process further comprises a step of incorporating at least one rubber selected from the group consisting of natural rubber, styrene-butadiene rubber, polybutadiene, cis-1,4-polyisoprene, acrylonitrile-butadiene copolymers EPDM rubber, butyl rubber and polychloroprene rubber in step (i) or (ii) or both.

In accordance with yet another aspect of the present disclosure there is provided a molded article comprising:
1. a thermo-reversible and self-healing blend comprising polybutadiene grafted on at least one polymer compounded with at least one ring compound containing at least one hetero-cyclic compound and at least one grafting enabling moiety wherein the polymer on which the ring compound is grafted is at least one selected from the group consisting of. Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (ASU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate, wherein the ring compound containing at least one hetero-cyclic compound and at least one grafting enabling moiety is at least one compound selected from the group consisting of Maleic anhydride, 2H-Pyran-2,6(3H)-dione, 2[5H]-furanone, furanone, 5,6-Dihydro-2H-pyran-2-one, 3,6-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one, preferably Maleic anhydride and at least one ring opening agent selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine, preferably 3-amino-1,2,4-triazole, at least one rubber selected from the group consisting of natural rubber, styrene-butadiene rubber, polybutadiene, cis-1,4-polyisoprene, acrylonitrile-butadiene copolymers, EPDM rubber, butyl rubber and polychloroprene rubber.
ii. optionally, at least one filler selected from the group consisting of carbon black, silica and nanoclay.

Typically, the grafting enabling moiety is an olefinic bond.

Typically, the proportion of the polybutadiene to the polymer ranges between 4:1 and 20:1.

Typically, the proportion of the polybutadiene to the ring compound containing at least one hetero-cyclic compound and at least one grafting enabling moiety ranges between 5:1 and 25:1

Typically, the proportion of the polybutadiene to the ring opening agent ranges between 5:1 and 25:1

Typically, the proportion of the ring compound containing at least one hetero-cyclic compound and at least one grafting enabling moiety to the ring opening agent ranges between 1:1 and 3:1.

Typically, the proportion of the polymer to the ring opening agent ranges between 0.3:1 and 2:1.

Typically, the proportion of the polymer grafted on at least one ring compound containing at least one hetero-cyclic compound and at least one grafting enabling moiety to the ring opening agent ranges between 1:10 and 10:1.

### BRIEF DESCRIPTION OF THE ACCOMPANYING DRAWINGS

The disclosure will now be explained in relation to the non limiting accompanying drawings, in which:

FIG. 1a illustrates a schematic representation of conventional cross-linking between polybutadiene rubber, crosslinked by sulfur vulcanization in accordance with the prior art;

FIG. 1b illustrates a schematic representation of blend of polybutadiene rubber (10) with maleated polymers (PP-MAH) (20), designated as B—P-M_{—}1, in accordance with an embodiment of the present disclosure;

FIG. 2a-FIG. 2c illustrate a schematic representation of various steps in the grafting of polybutadiene (10) with maleated polymers (PP-MAH) (20) and ring opening agent (30) to get thermo-reversible B—P-M-X_{—}2, (200) in accordance with an embodiment of the present disclosure;

FIG. 3 illustrates a schematic representation of a B—P-M-X_{—}2, (200) in accordance with another embodiment of the present disclosure;

FIG. 4 illustrates a schematic representation depicting sequence of the steps involved in the preparation of the polybutadiene rubber blend in accordance with an embodiment of the present disclosure;

FIG. 5a illustrates a typical stress-strain curve for a polybutadiene rubber blend of grade C;

FIG. 5b illustrates a typical stress-strain curve for a conventionally vulcanized polybutadiene rubber;

FIG. 6 illustrates tensile strength of the samples of fresh thermo-reversible B—P-M-X_{—}2 and tensile strength of samples of re-cycled thermo-reversible B—P-M-X_{—}3;

FIG. 7 illustrates a graph depicting variation in Tan delta vs. Temperature for thermo-reversible B—P-M-X_{—}2;

FIG. 8a-FIG. 8c illustrates POM images showing healing-process exhibited by a sample of thermo-reversible B—P-M-X_{—}2, (200) in accordance with an embodiment of the present disclosure;

FIG. 8d illustrates a POM image of a conventionally vulcanized polybutadiene rubber;

FIG. 9a illustrates a schematic representation of a sample of thermo-reversible B—P-M-X_{—}2, (200) compounded with carbon black, in accordance with another embodiment of the present disclosure;

FIG. 9b illustrates a schematic representation of a sample of conventionally vulcanized polybutadiene, rubber compound;

FIG. 10a illustrates a maleated polypropylene sample; and

FIG. 10b illustrates a blend of maleated polypropylene and 3-amino-1,2,4-triazole.

### DETAILED DESCRIPTION

A preferred embodiment will now be described in detail with reference to the accompanying drawings. The preferred embodiment does not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

In accordance with one aspect of the present disclosure there is provided a thermo-reversible and self-healing blend comprising polybutadiene (10) that is compounded with at least one ring opening agent (30) and at least one ring compound containing at least one hetero-cyclic compound and at least one grafting enabling moiety. The grafting enabling moiety in the ring compound is an olefinic bond. The ring compound bonded with the ring opening agent is grafted on at least one position of the backbone of a polymer (20). The ring opening agent is such that it is capable of opening the ring compound to provide at least one open functional group to which the ring opening agent is capable of bonding. This phenomenon imparts: thermo-reversibility and self-healing properties to the blend of the present disclosure. The ring compounds containing at least one hetero-cyclic compound and at least one grafting enabling moiety is capable of grafting on the back bone of a polymer through the grafting enabling moiety. The polymer on which the ring compound is capable of being grafted is at least one compound selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychiorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

The ring compounds containing at least one hetero-cyclic compound and at least one grafting enabling moiety are generally selected from the group consisting of anhydrides, imides, thioanhydrides, lactones, lactams, thiolactones, epoxides and the combinations thereof. Particularly, the ring compound containing at least one hetero-cyclic compound and at least one grafting enabling moiety is selected from the group of compounds consisting Maleic anhydride, 2H-Pyran-2,6(3H)-dione, 2[5H]-furanone, furanone, 5,6-Dihydro-2H-pyran-2-one, 3,6-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one and combinations thereof. In a preferred embodiment, maleic anhydride is the ring compound. The open functional group that results from the ring compound after opening by the ring opening agent are bonded to the ring opening agents through at least one type of linkage such as covalent bond, ionic bond, polar covalent bond, electrovalent bond, H-bond, zwitter ion bond, electron-pair bond, co-ordinate covalent bond, van der Waals forces, mechanical bond, cation-pi interaction, anion-pi interaction and combinations thereof. In one of the preferred embodiments the open functional group is bonded to the ring opening agent through at least one covalent bond. Moreover, the open functional groups of the ring compound are also capable of bonding to each other through different types of linkages such as covalent bond, ionic bond, polar covalent bond, electrovalent bond, H-bond, zwitter ion bond, electron-pair bond, co-ordinate covalent bond, van der Waals forces, mechanical bond, cation-pi interaction, anion-pi interaction and combinations thereof. The supra-molecular structure that results from the various types of bonding, imparts desired characteristics to the blend. The supra-molecular structure also makes the polybutadiene rubber of the present disclosure recyclable. The inventors of the present disclosure after conducting several trials in the laboratory have found that the specific type of ring opening agent in a particular proportion plays a vital role in deciding the characteristics of the blend. Therefore, the type and the proportion of the ring opening agent should be such that the requisite characteristic properties of the blend are achieved. The ring opening agent is selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluorornethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine and combinations thereof. The ring opening agent is preferably 3-amino-1,2,4-triazole.

The ring compound containing at least one hetero-cyclic compound and at least one grafting enabling moiety is further grafted on at least one position of the polymer. The polymer to which the ring compound is grafted is selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF), Ethylene methyl acrylate and combinations thereof. The proportion of the polybutadiene to the polymer ranges between 4:1 and 20:1. The polymer post grafting (20) may be prepared by grafting any ring compound containing at least one hetero atom and at least one grafting enabling moiety to polyolefin in a melt reaction at a rate and under conditions effective to produce a grafting reaction product. In an exemplary embodiment polyethylene may be reacted/grafted with maleic anhydride to produce maleated polyethylene. The proportion of the polybutadiene to the ring compound containing at least one hetero-cyclic compound and at least one grafting enabling moiety ranges between 5:1 and 25:1. Similarly, the proportion of the polybutadiene to the ring opening agent ranges between 5:1 and 25:1. Further, the proportion of the ring compound containing at least one hetero-cyclic compound and at least one grafting enabling moiety to the ring opening agent ranges between 1:1 and 3:1. Still further, the proportion of the polymer to the ring opening agent ranges between 0.3:1 and 2:1. Still further, the proportion of the polymer grafted on at least one ring compound containing at least one hetero-cyclic compound and at least one grafting enabling moiety to the ring opening agent ranges between 1:10 and 10:1.

Further, to the surprise of the inventors it is observed that the blend of the present disclosure is compatible with other fillers which includes carbon black, silica and nano-fillers such as nanoclay and the like and combinations thereof. The fillers may be employed without any adverse effect to enhance the properties of the resultant polybutadiene rubber blend. The polybutadiene rubber blend, further, also may comprise at least one rubber selected from the group consisting of natural rubber, styrene-butadiene rubber, polybutadiene, cis-1,4-polyisoprene, acrylonitrile-butadiene copolymers EPDM rubber, butyl rubber and polychloroprene rubber. The tensile strength of the blend ranges between 0.1 MPa and 1.0 MPa.

In accordance with another aspect of the present disclosure there is provided a process for preparing a thermo-reversible and self-healing blend comprising polybutadiene compounded with at least one ring opening agent and at least one ring compound containing at least one hetero-cyclic compound and a grafting enabling moiety. The grafting enabling moiety in the ring compound is an olefinic bond.

In the first step, polybutadiene and at least one ring compound containing at least one hetero-cyclic compound and at least one grafting enabling moiety, grafted on at least one position of the backbone of a polymer is melt mixed to obtain a grafted mixture.

The ring compound containing at least one hetero-cyclic compound and at least one grafting enabling moiety is selected from the group consisting of Maleic anhydride, 2H-Pyran-2,6(3H)-dione, 2[5H]-furanone, furanone, 5,6-Dihydro-2H-pyran-2-one, 3;6-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one and combinations thereof. Preferably, maleic anhydride is used as ring compound. Further, the polymer is selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF), Ethylene methyl acrylate and combinations thereof. The first step is generally carried out at a temperature of 165° C. to 195° C. accompanied by stirring at a speed ranging between 30 rpm and 60 rpm for a time period ranging between 0.5 hrs and 2.0 hrs.

The second step comprises adding at least one ring opening agent to the grafted mixture to obtain a blend. The ring opening agent is such that it opens the ring compound to provide at least one open functional group of the ring compound to which the ring opening agent gets bonded. The ring opening agent is selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thio1-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine and combinations thereof. Preferably, 3-amino-1,2,4-triazole is the ring opening agent. In this step, the open functional group may link to the ring opening agent and/or to each other. Both the type of linkages are selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction, anion-pi interaction and combinations thereof. In one embodiment the open functional group link to the ring opening agent through at least one covalent bond. The second step is carried out at a temperature ranging between 165° C. and 195° C., accompanied by stirring at a speed ranging between 30 rpm and 60 rpm for a time period ranging between 0.5 hrs and 5.0 hrs.

The quantities of the components involved in the process of the present disclosure are established with respect to each other. The proportion of the polybutadiene to the polymer ranges between 4:1 and 20:1. The proportion of the polybutadiene to the ring compound containing at least one hetero-cyclic compound and at least one grafting enabling moiety ranges between 5:1 and 25:1. The proportion of the polybutadiene to the ring opening agent ranges between 5:1 and 25:1. The proportion of the ring compound containing, at least one hetero-cyclic compound and at least one grafting enabling moiety to the ring opening agent ranges between 1:1 and 3:1. The proportion of the polymer to the ring opening agent ranges between 0.3:1 and 2:1. The proportion of the polymer grafted on at least one ring compound containing at least one hetero-cyclic compound and at least one grafting enabling moiety to the ring opening agent ranges between 1:10 and 10:1.

As the blend of the present disclosure is compatible with different fillers such as carbon black, the process of the present disclosure further comprises a step of incorporating fillers selected from the group consisting of carbon black, silica and nano-fillers such as nanoclay and the like and combinations thereof, in either the first or the second step or in both the steps. The process of the present disclosure may also comprise a step of incorporating at least one rubber selected from the group consisting of natural rubber, styrene-butadiene rubber, polybutadiene, cis-1,4-polyisoprene, acrylonitrile-butadiene copolymers EPDM rubber, butyl rubber and polychloroprene rubber in step (i) or (ii) or both.

In accordance with yet another aspect of the present disclosure, there is provided a molded article prepared from a thermo-reversible and self-healing blend. The blend comprises polybutadiene that is grafted on at least one polymer, which in turn is compounded with at least one ring compound containing at least one hetero-cyclic compound and at least one grafting enabling moiety. The grafting enabling moiety is an olefinic bond. The polymer is selected from the group consisting Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF), Ethylene methyl acrylate and combinations thereof. Further, the ring compound containing at least one hetero-cyclic compound and at least one grafting enabling moiety is selected from the group consisting of Maleic anhydride, 2H-Pyran-2,6(3H)-dione, 2 [5H]-furanone, furanone, 5,6-Dihydro-2H-pyran-2-one, 3,6,-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one and combinations thereof. Preferably, the ring compound is maleic anhydride. The ring opening agent is at least one selected from the group consisting 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine and preferably, is 3-amino-1,2,4-triazole. The rubber is selected from the group consisting of natural rubber, styrene-butadiene rubber, polybutadiene, cis-1,4-polyisoprene, acrylonitrile-butadiene copolymers EPDM rubber, butyl rubber and polychloroprene rubber and combinations thereof. The molded article optionally contains a filler selected from the group consisting of carbon black, silica and nano-fillers such as nanoclay and combinations thereof.

The proportion of the polybutadiene to grafted polymer in the molded article ranges between 4:1 and 20:1. The proportion of the polybutadiene to the ring compound containing at least one hetero-cyclic compound and at least one grafting enabling moiety ranges between 5:1 and 25:1. Similarly, the proportion of the polybutadiene to the ring opening agent ranges between 5:1 and 25:1. Further, the proportion of the ring compound containing at least one hetero-cyclic compound and at least one grafting enabling moiety to the ring opening agent ranges between 1:1 and 3:1. Even further, the proportion of the polymer to the ring opening agent ranges between 0.3:1 and 2:1. Similarly, the proportion of the polymer grafted on at least one ring compound containing at least one hetero-cyclic compound and at least one grafting enabling moiety to the ring opening agent ranges between 1:10 and 10:1.

The thermo-reversible blend of the present disclosure exhibits self-healing properties in the temperature range of 40-85° C. that are mostly faced by rubber products such as tyres operating under dynamic use conditions. Further, the thermo-reversible blend is a two-phase blend. Due to the presence of polybutadiene phase it can be blended with other general purpose rubbers such as natural rubber and styrene-butadiene rubber and accordingly can be commercially exploited in the manufacture of tyres.

The present disclosure is further described in light of the following examples which, are set forth for illustration purpose only and not to be constructed for limiting the scope of the disclosure.

### EXAMPLE 1

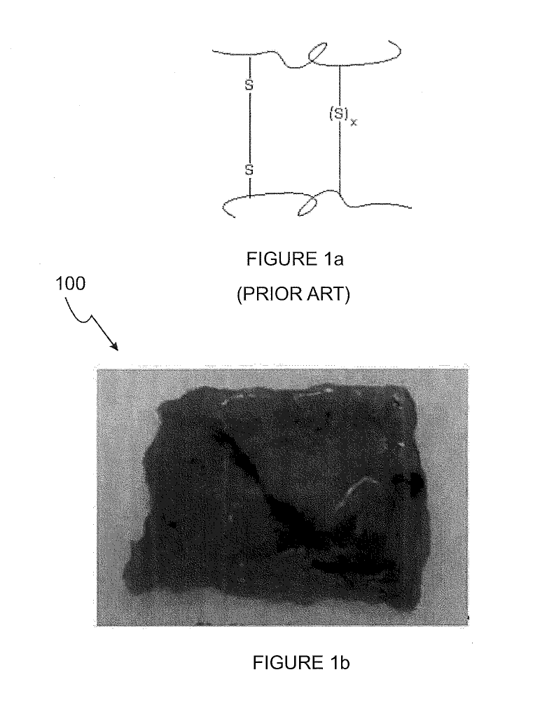

20 gm of polybutadiene rubber (BR) (Cisamer 01 and Cisamer 1220 grades, ML₁₊₄ at 100° C.=45) was fed into a Brabender Plasticorder (PL 2000) at a set temperature of 165° C. After 2 min, 5 g of PP-MAH (maleated polypropylene) having a melting temperature of 143° C. (AC®597 of Honeywell) was added into it. The mixing was continued for 6 min at 60 rpm to have a blend of BR and PP-MAH at 80:20 ratio. The blend 100 is designated as B—P-M_{—}1. The, blend was then passed through a cold two-roll mill. Then the blend was compression molded at 155° C. under 10 MPa pressure for 5 min in a mold of 10×15×0.2 cm dimension. But the shaping of the material was not possible due to lack of crosslinking between the polymer chains (FIG. 1).

In order to enhance the cross-linking between the polymer chains and facilitate shaping of the B—P-M_{—}1, further processing was carried on the B—P-M_{—}1 (100).

### EXAMPLE 2

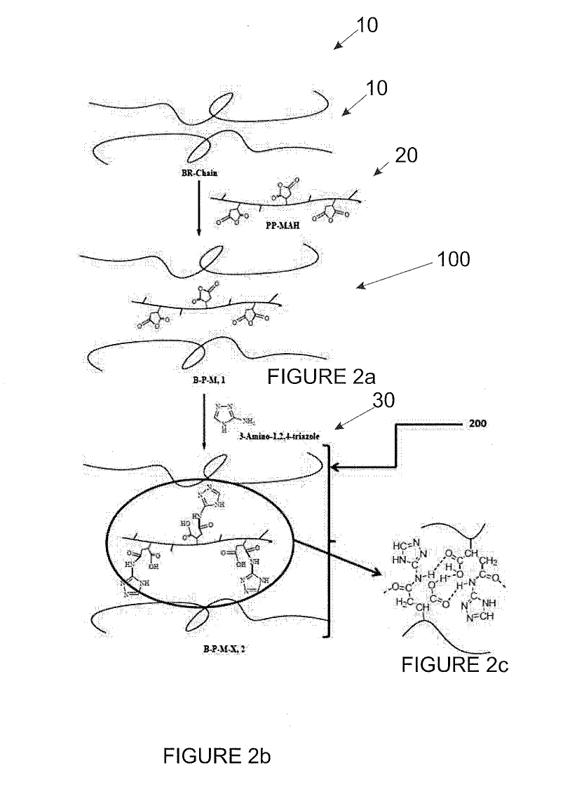

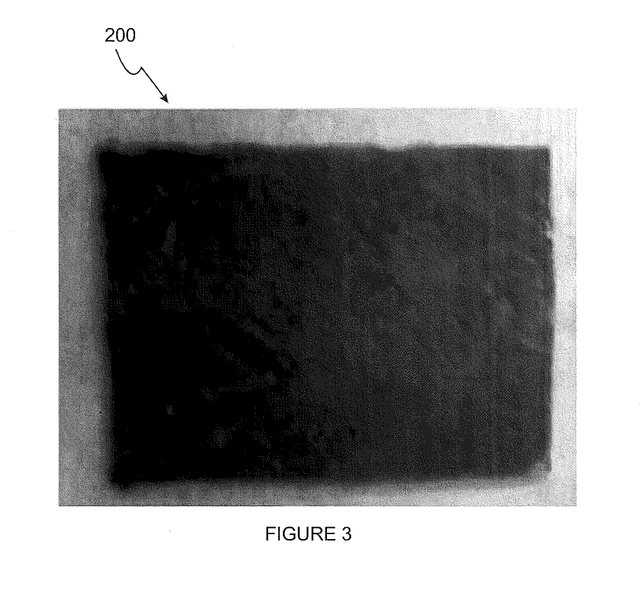

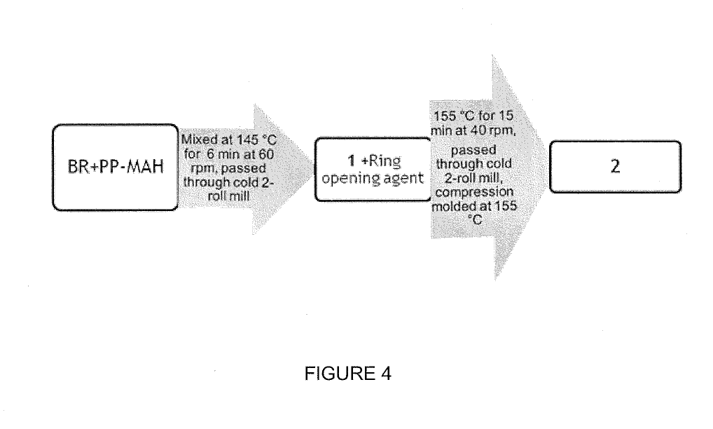

22.7 gm of B—P-M_{—}1 (100) blend was added to a Brabender Plasticorder (PL 2000) at a set temperature of 175° C. After 2 min, 2.7 gm of 3-amino-1,2,4-triazole (from Alfa-Aesar) having a melting temperature of 150-153° C. was added to it to obtain a mixture. The mixture was then stirred for 15 minutes at a temperature 175° C. and 40 rpm (Caution-Mixing time of more than 15 min, causes degradation of the material i.e., material turns brown and sticky). The material was then passed through a cold two-roll mill and compression molded at a temperature of 155° C. under 10 MPa pressure for 3 min in a mold of 10×15×0.2 cm dimension to obtain a sheet B—P-M-X_{—}2 (FIG. 2).

### EXAMPLE 3

The composition of polybutadiene rubber (BR) 10 with maleated polypropylene, rpm of the mixer, retaining time in the mixer, the quantity of the ring opening agent 30 along with other parameters were varied to get different grades of blend of polybutadiene rubber (Table No. 1). The different grades blends of polybutadiene rubber obtained are designated by A, B, C, and D. The different grades of blend of polybutadiene rubber exhibit different properties for example different tensile strength. The Table No. 1 depicts the variation in the properties of the blend of polybutadiene rubber with variation in the composition of polybutadiene rubber (BR) 10 with maleated polypropylene, rpm of the mixer, retaining time in the mixer, the quantity of the ring opening agent 30.

TABLE NO. 1

Sample

| | | | | |
|---|---|---|---|---|
| Conditions | A | B | C | D |

| | | | | | |
|---|---|---|---|---|---|
| Step 1 | BR, phr* | 80 | 95 | 80 | 80 |
| | PP-MAH, phr | 20 | 5 | 20 | 20 |
| | RPM | 60 | 60 | 60 | 60 |
| | TIME, min | 6 | 6 | 6 | 6 |
| Step 2 | MAH:3-amino- | 1:1 | 1:1 | 3:1 | 1:2 |
| | 1,2,4-triazole | | | | |
| | RPM | 40 | 40 | 40 | 40 |
| | TIME, min | 15 | 15 | 15 | 15 |
| Properties | Tensile strength, | 0.81 | — | — | 0.32 |
| | MPa | | | | |

*parts per hundred parts of rubber

Well-shaped sheets were formed in the case of A and D. The sheet formation was not observed in the case of B, where PP-MAH content was very low and in C where the content of 3-amino-1,2,4-triazole was less compared to MAH content.

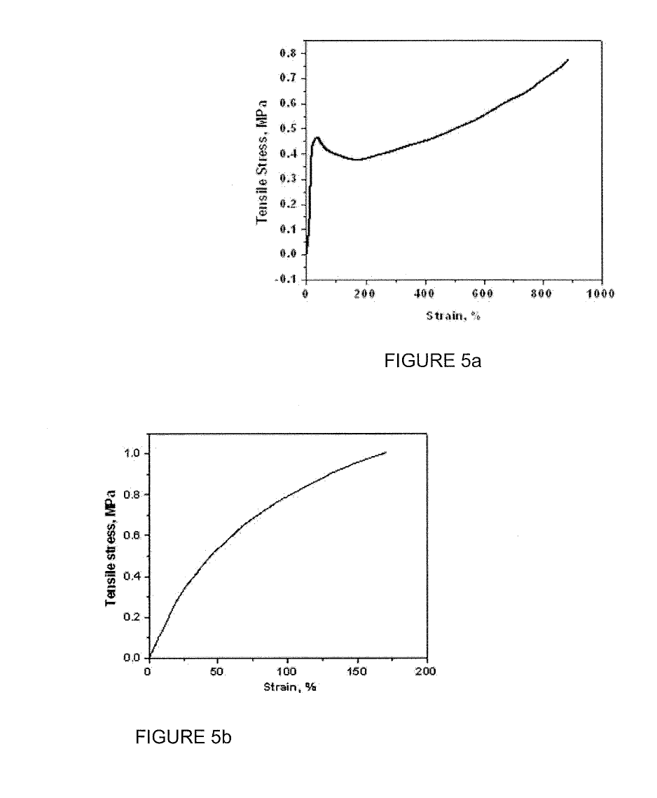

FIG. 5a illustrates a typical stress-strain curve for a polybutadiene rubber blend of grade C. FIG. 5b illustrates a typical stress-strain curve for conventionally vulcanized polybutadiene rubber (BR). By comparing the stress strain curve for polybutadiene rubber blend of grade C with that of the stress-strain curve for conventionally vulcanized polybutadiene rubber (BR), it is evident that polybutadiene rubber blend of grade C exhibits better mechanical properties as compared to conventionally vulcanized polybutadiene rubber (BR).

### EXAMPLE 4

Some other ring-opening agents were tried to open maleic anhydride ring. The formulation and results obtained by using various ring-opening agents are reported in Table 2.

TABLE 2

| | | Sample | | | |
|---|---|---|---|---|---|
| Conditions | | E | F | G | H |
| Step-1 | BR, phr | 80 | 80 | 80 | 80 |
| | PP-MAH, | 20 | 20 | 20 | 20 |
| | phr | | | | |
| | RPM | 60 | 60 | 60 | 60 |
| | TIME, min | 6 | 6 | 6 | 6 |
| Step-2 | MAH:ring- | 1:1 | 1:1 | 1:1 | 1:1 |
| | opening | | | | |
| | agent | | | | |
| | RPM | 40 | 40 | 40 | 40 |
| | TIME, min | 15 | 15 | 15 | 15 |
| | Type of | PEG- | Diphenyl | PEG-200 | 1-Phenyl- |
| | ring | 6000 | guanidine | | 1,2-ethanediol |
| | opening | | | | |
| | agent | | | | |
| Properties | Tensile | — | 0.26 | — | 0.20 |
| | strength, | | | | |
| | MPa | | | | |

Well shaped sheets could not be formed with PEG as ring opening agents. The recycling was done at set temperature of 165-195° C. and 30-60 rpm. The sample was remolded in a compression molding press at 150-170° C. to give molded article. The thermo-reversibility could be observed in Molded article till n^{th} cycle where n=2-5.

### EXAMPLE 5

The thermo-reversible B—P-M-X 2 (hereinafter referred to as thermo-reversible B—P-M-X_{—}2, 200) was recycled.

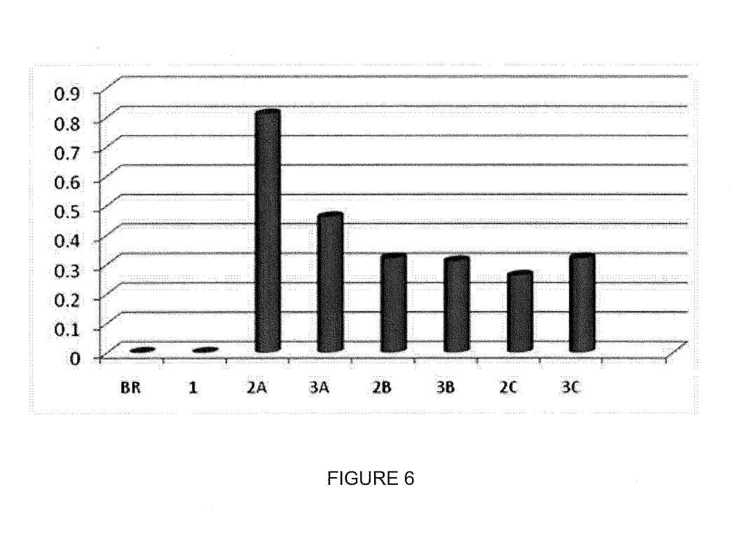

The remaining sheet and test-Pieces of B—P-M-X_{—}2, 200 was fed into Brabender Plasticorder at a set temperature of 175° C. It was then remixed for 2 min at 40 rpm. The material was then passed through a cold two-roll mill and molded in a compression molding press for 3 min at 155° C. under 10 MPa pressure. The procedure was repeated n^{th} time. In order to determine the change in mechanical properties of the component made from fresh thermo-reversible B—P-M-X_{—}2, 200 and recycled thermo-reversible B—P-M-X_{—}2, tests were conducted. FIG. 6 illustrates the tensile strength of the samples of fresh thermo-reversible B—P-M-X_{—}2 and samples of re-cycled thermo-reversible B—P-M-X_{—}2. More specifically, FIG. 6 illustrates variation in the tensile strength of the samples with variation in type of the ring opening agents 30 used and ratio of the ring opening agent with respect to the maleic anhydride MAH in the blend wherein “A” denotes a Polybutadiene rubber blend that uses 3-amino-1,2,4-triazole as the ring opening agent, and the ratio of triazole: MAH is 1:1, “B” denotes a Polybutadiene rubber blend that uses 3-amino-1,2,4-triazole as the ring opening agent, and the ratio of triazole: MAH is 2:1 and “C” denotes a Polybutadiene rubber blend that uses Diphenyl guanidine as the ring opening agent and the ratio of guanidine: MAH is 1:1.

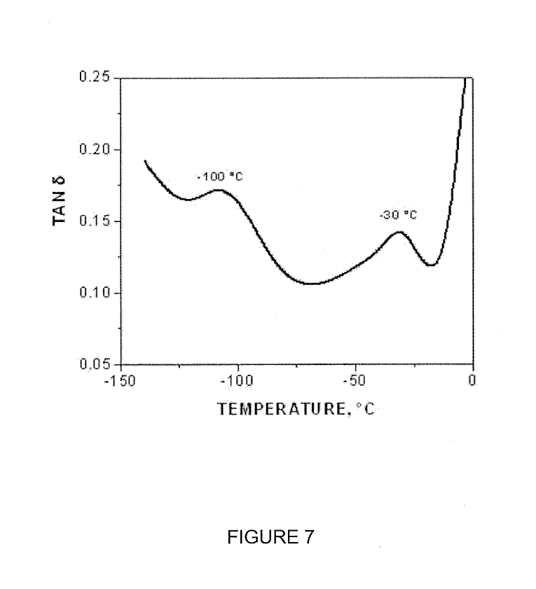

The thermo-reversible B—P-M-X_{—}2 is a bi-phasic material as evident from dynamic mechanical studies. The glass-transition temperature (Tg) of the two polymeric materials can be distinctly observed in FIG. 7. Tg of BR and PP-MAH is observed at −100 and −30° C. The Tg of both the polymers in the blend have come closer to each-other, as compared with the individual Tg. It indicates that it is a compatible blend.

The glass transition temperature (Tg) of individual materials, as analyzed through Differential scanning calorimetry (DSC), are reported in Table No. 3. The Tg of PP-MAH, as observed through DSC analysis, is at 13.2° C., which cannot be observed in the BR: PP-MAH blend. The DMA results of the blend shows Tg of PP-MAH phase at −30° C. (FIG. 7). No transition of PP-MAH at ˜13° C. can be observed in DSC curves as it might be lowered and merged with the melting transition of BR phase.

TABLE 3

| | Transitions observed in |
|---|---|
| | DSC (° C.), method |
| Sample | ASTM E 1356 |
| BR | Tg = −109.0 |
| | Tc = −74.1 |
| | Tm = −8.0 |
| PP-MAH | Tg = 13.2 |
| | Tm = 139.8 |
| BPM_1 | Tg = −109.1 |
| | Tc = −78.4 |
| | Tm = −7.0 |
| BPMT_2 | Tg = −109.2 |
| | Tc = −76.8 |
| | Tm = −9.9 |
| 3-amino-1,2,4- | Tg = 97.4 |
| Triazole | Tm = 158.2 |

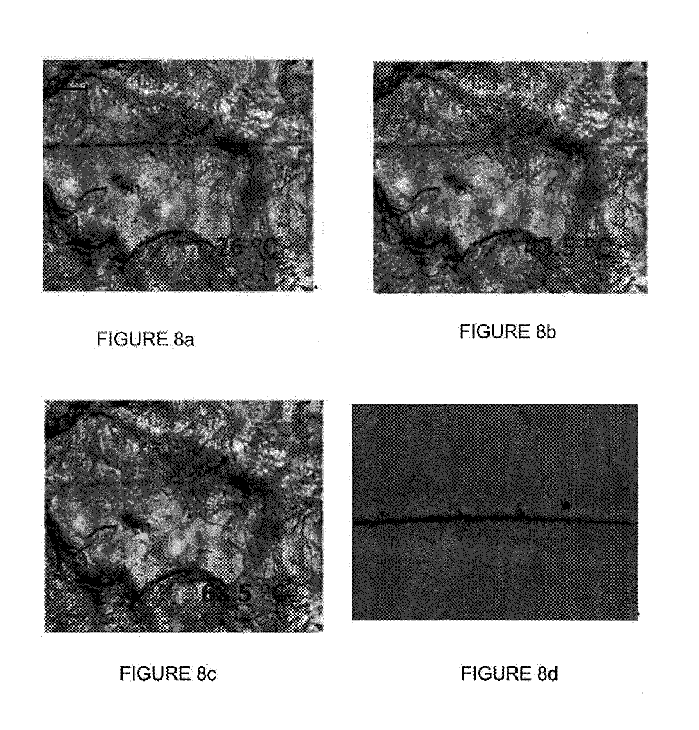

The thermo-reversible B—P-M-X_{—}2 can heal micro-cracks by itself as shown in FIG. 8a-FIG. 8c. The healing process initiates with temperature in the range of 40-85° C. The crack heals itself without changing the overall morphology of the blend, as seen through polarized optical microscope images. However, in case of conventionally vulcanized BR, the phenomenon of healing of micro-cracks cannot be observed and accordingly such cracks remain unaltered with temperature. FIG. 8d illustrates POM image of a of conventionally vulcanized polybutadiene rubber blend (BR).

### EXAMPLE 6

### Compatibility of B—P-M-X_{—}2, 200 with Fillers

The thermo-reversible B—P-M-X_{—}2 was compounded with carbon black as per the formulation below in order to enhance the properties of the resultant polybutadiene rubber blend. The melt-mixing procedure remained same as for preparation of the thermo-reversible B—P-M-X_{—}2.

TABLE 4

| Ingredients | phr |
|---|---|
| 2A | 100 |
| Carbon black | 60 |
| Oil | 8 |

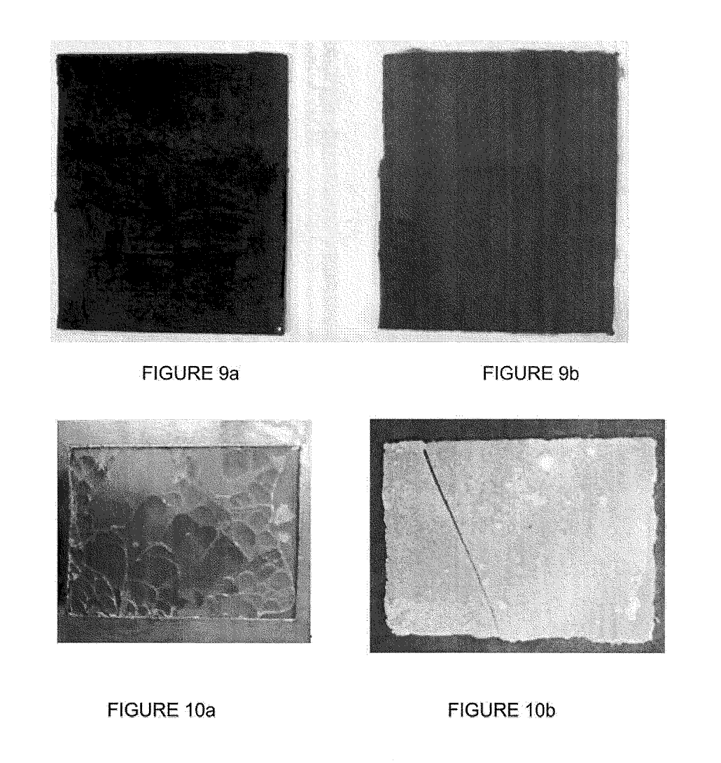

The resulting sample was molded as per the molding procedure for preparation of thermo-reversible B—P-M-X_{—}2. The H-bond formation is active even in presence of 60 phr of filler, carbon black. The sheet formed is shown in FIG. 9.

The thermo-reversible B—P-M-X_{—}2 has filler taking ability like general purpose rubbers

### EXAMPLE 7

PP-MAH and a blend of PP-MAH-3-amino-1,2,4-triazole were molded in a similar way using compression molding. But the samples were too brittle to be tested further. FIG. 10a illustrates a PP-MAH sample and FIG. 10b illustrates a blend of PP-MAH and 3-amino-1,2,4-triazole.

### Example 8

22.7 gm of B—P-M_{—}1 (100) blend was added to a Brabender Plasticorder (PL 2000) at a set temperature of 175° C. After 2 min, a ring opening agent in a specified proportion as mentioned in Table 5 was added to it to obtain a mixture. The mixture was then stirred for 15 minutes at a temperature 175° C. and 40 rpm (Caution-Mixing time of more than 15 min, causes degradation of the material i.e., material turns brown and sticky). The material was then passed through a cold two-roll mill and compression molded at a temperature of 155° C. under 10 MPa pressure for 3 min in a mold of 10×15×0.2 cm dimension to obtain a sheet. The results are provided in Table 5.

TABLE 5
Effect of variation of ring opening agents

| | | | | |
|---|---|---|---|---|
| Sr. | | Ratio of | Tensile | Sheet |
| No. | Ring Opening Agents (ROA) | MAH:ROA | Strength | formation |

Nitrogen-containing ROA

| | | | | |
|---|---|---|---|---|
| 1 | 3-amino-1,2,4-triazole | 1:1 | 0.81 | Yes |
| 2 | 3-amino-1,2,4-triazole | 1:2 | 0.32 | Yes |
| 3 | 3-amino-1,2,4-triazole | 1:3 | — | No |
| 4 | 3-amino-5-thiol-1,2,4-triazole | 1:1 | — | Sticky |
| 5 | Urea | 1:1 | 0.26 | Yes |
| 6 | Diphenyl guanidine | 1:1 | 0.26 | Yes |
| 7 | Diethylene triamine (DETA) | 1:1 | — | No |
| 8 | Melamine | 1:1 | — | No |
| 9 | 3-amino-1,2,4-triazole + | 1:(0.5 + 0.5) | 0.70 | Yes |
| | Melamine | | | |
| 10 | 3-amino-1,2,4-triazole + | 1:(0.5 + 0.5) | 0.25 | Yes |
| | cyclodextrin | | | |
| 11 | 2-Hydrazino-4- | 1:1 | 0.23 | Yes |
| | (Trifluoromethyl)pyridimine, | | | |

Oxygen-containing ROA

| | | | | |
|---|---|---|---|---|
| 12 | PEG-6000 | 1:1 | — | No |
| 13 | PEG-6000 | 1:1 | — | Degrading |
| 14 | 1-Phenyl-ethane-1,2-diol | 1:1 | — | No |

Amino acids as a ROA

| | | | | |
|---|---|---|---|---|
| 15 | L-Alanine benzyl ester p- | 1:1 | 0.24 | Yes |
| | toluenesulfonate salt | | | |
| 16 | L-Cysteine ethyl ester | 1:1 | 0.35 | Yes |
| | hydrochloride | | | |
| 17 | L-Methionine ethyl ester | 1:1 | 0.33 | Yes |
| | hydrochloride | | | |
| 18 | L-Phenylalanine methyl ester | 1:1 | 0.25 | Yes |
| | hydrochloride | | | |
| 19 | N-(3-indolylacetyl)-L-alanine | 1:1 | 0.25 | Yes |

Technical Advancement and Economic Significance

The polybutadiene rubber blend in accordance with the present disclosure has several technical advantages including but not limited to the realization of
polybutadiene rubber blend for configuring products exhibiting improved operational life;
polybutadiene rubber blend that exhibits thermo-reversible self-healing properties;
polybutadiene rubber blend that exhibits wear resistant properties;
polybutadiene rubber blend that can with-stand tougher operational conditions;
polybutadiene rubber blend that enhances quality and performance of the products configured there-from;
polybutadiene rubber blend that can be economically and conveniently manufactured; and
polybutadiene rubber blend that eliminates the drawbacks associated with cross-linking systems such as sulfur vulcanization used in manufacturing of tyres from polybutadiene.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A thermo-reversible and self-healing blend comprising polybutadiene compounded with at least one ring opening agent and at least one ring compound containing at least one hetero-cyclic compound and at least one grafting enabling moiety, wherein the ring opening agent is capable of opening the ring compound to provide at least one open functional group to which the ring opening agent is capable of bonding, and wherein the ring compound is capable of grafting on the backbone of a polymer through the grafting enabling moiety.

2. The blend as claimed in claim 1, wherein the grafting enabling moiety is an olefinic bond.

3. The blend as claimed in claim 1, wherein the open functional group is bonded to the ring opening agent through at least one linkage selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction and anion-pi interaction.

4. The blend as claimed in claim 1, wherein the open functional group is bonded to the ring opening agent through at least one covalent bond.

5. The blend as claimed in claim 1, wherein there are at least two open functional groups are capable of bonding to each other through at least one linkage selected from the group consisting of covalent bond, ionic bond, polar covalent bond, electrovalent bond, H-bond, zwitter ion bond, electron-pair bond, co-ordinate covalent bond, van der Waals forces, mechanical bond, cation-pi interaction and anion-pi interaction.

6. The blend as claimed in claim 1, wherein the ring compound contains at least one hetero-cyclic compound and at least one grafting enabling moiety is at least one compound selected from the group consisting of anhydrides, imides, thioanhydrides, lactones, lactams, thiolactones and epoxides.

7. The blend as claimed in claim 1, wherein the ring compound contains at least one hetero-cyclic compound and at least one grafting enabling moiety is at least one compound selected from the group consisting of Maleic anhydride, 2H-Pyran-2,6(3H)-dione, 2[5H]-furanone, furanone, 5,6-Dihydro-2H-pyran-2-one, 3,6-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one, preferably Maleic anhydride.

8. The blend as claimed in claim 1, wherein the blend comprises a polymer on which the ring compound is capable of being grafted, said polymer is at least one compound selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thennoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

9. The blend as claimed in claim 1, wherein the ring compound is grafted on at least one polymer selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate.

10. The blend as claimed in claim 1, wherein the ring opening agent is at least one selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine, preferably 3-amino-1,2,4-triazole.

11. The blend as claimed in claim 1, wherein the proportion of the polybutadiene to polymer ranges between 4:1 and 20:1; the proportion of the polybutadiene to the ring compound containing at least one hetero-cyclic compound and at least one grafting enabling moiety ranges between 5:1 and 25:1; the proportion of the polybutadiene to the ring opening agent ranges between 5:1 and 25:1; the proportion of the ring compound containing at least one hetero-cyclic compound and at least one grafting enabling moiety to the ring opening agent ranges between 1:1 and 3:1; the proportion of the polymer to the ring opening agent ranges between 0.3:1 and 2:1; and the proportion of the polymer grafted on at least one ring compound containing at least one hetero-cyclic compound and at least one grafting enabling moiety to the ring opening agent ranges between 1:10 and 10:1.

12-16. (canceled)

17. The blend as claimed in claim 1, further comprising at least one filler selected from the group consisting of carbon black, silica and nanoclay.

18. The blend as claimed in claim 1, further comprising at least one rubber selected from the group consisting of natural rubber, styrene-butadiene rubber, polybutadiene, cis-1,4-polyisoprene, acrylonitrile-butadiene copolymers EPDM rubber, butyl rubber and polychloroprene rubber.

19. The blend as claimed in claim 1, wherein the tensile strength of the blend ranges between 0.1 MPa and 1.0 MPa.

20. A process for preparing a thermo-reversible and self-healing blend comprising polybutadiene compounded with at least one ring opening agent and at least one ring compound containing at least one hetero-cyclic compound and at least one grafting enabling moiety, said process comprising the following steps:
a. melt mixing polybutadiene and at least one ring compound containing at least one hetero-cyclic compound and at least one grafting enabling moiety grafted on at least one position of the backbone of a polymer to obtain a grafted mixture; and
b. adding at least one ring opening agent to the grafted mixture to obtain a blend, wherein the ring opening agent opens the ring compound to provide at least one open functional group of the ring compound to which the ring opening agent gets bonded.

21-35. (canceled)

36. The process as claimed in claim 20, the method step of melt mixing is carried out at a temperature of 165° C. to 195° C. with stirring at a speed ranging between 30 rpm and 60 rpm for a time period ranging between 0.5 hrs and 2.0 hrs.

37. The process as claimed in claim 20, the method step of adding is carried out at a temperature ranging between 165° C. and 195° C. with stirring at a speed ranging between 30 rpm and 60 rpm for a time period ranging between 0.5 hrs and 5.0 hrs to obtain a blend.

38. The process as claimed in claim 20, further comprises a step of incorporating at least one filler selected from the group consisting of carbon black and silica and nanoclay in step (i) or (ii) or both.

39. The process as claimed in claim 20, further comprises a step of incorporating at least one rubber selected from the group consisting of natural rubber, styrene-butadiene rubber, polybutadiene, cis-1,4-polyisoprene, acrylonitrile-butadiene copolymers EPDM rubber, butyl rubber and polychloroprene rubber in step (i) or (ii) or both.

40. A molded article comprising:
a. a thermo-reversible and self-healing blend comprising polybutadiene grafted on at least one polymer compounded with at least one ring compound containing at least one hetero-cyclic compound and at least one grafting enabling moiety wherein the polymer on which the ring compound is grafted is at least one selected from the group consisting of Polybutadiene, Olefin-diene copolymer, Olefin-diene terpolymer, styrene-diene copolymer, Acrylonitrile diene styrene copolymer, Cellulose, Cellulose acetate, Ethyl cellulose, Fluoroplastics (PTFE) Cyclic Olefin Copolymer (COC), Ethylene-Vinyl Acetate (EVA), acrylic/PVC alloy, Ethylene Vinyl Alcohol (EVOH), Liquid Crystal Polymer (LCP), Polyoxymethylene (POM or Acetal), Polyacrylates (Acrylic), Polyacrylonitrile (PAN or Acrylonitrile), Polyaryletherketone (PAEK or Ketone), Polybutylene terephthalate (PBT), Polybutylene, Polyisobutylene, Polybutadiene, Polycaprolactone (PCL), Polychlorotrifluoroethylene (PCTFE), Polyethylene terephthalate (PET), Polycyclohexylenedimethylene terephthalate (PCT), Polyhydroxyalkanoates (PHAs), Polyketone (PK), Polyester, Polyethylene (PE), Polyetheretherketone (PEEK), Polyetherketoneketone (PEKK), Polyethersulfone (PES)/Polysulfone, Chlorinated Polyethylene (CPE), Polylactic acid (PLA), Polymethylpentene (PMP), Polyphenylene oxide (PPO), Polyphenylene sulfide (PPS), Polypropylene (PP), Polystyrene (PS), Polysulfone (PSU), Polytrimethylene terephthalate (PTT), Polyvinyl acetate (PVAc), Polyvinyl alcohol(PVA), Polyvinyl chloride (PVC), Polyvinylidene chloride (PVDC), High Density Polyethylene (HDPE), Low Density Polyethylene (LDPE), Polyvinyl Chloride (PVC), Polymethylmethacrylate (PMMA), p-Polycarbonate (PC), Polyaryletherketone (PAEK) and Self-reinforced polyphenylene (SRP), Polyvinylidene chloride (PVDC), Styrene-acrylonitrile (SAN), Polychlorotrifluoroethylene (PCTFE), Nylon, Teflon, Thermoplastic polyurethanes, Phenol-formaldehyde resin, Para-aramid, Polychloroprene, Polyimide, aromatic polyester, poly-p-phenylene-2,6-benzobisoxazole (PBO), Polyethylene glycol (PEG), Polyurethane (PU), Polyvinylidene fluoride (PVDF) and Ethylene methyl acrylate, wherein the ring compound containing at least one hetero-cyclic compound and at least one grafting enabling moiety is at least one compound selected from the group consisting of Maleic anhydride, 2H-Pyran-2,6(3H)-dione, 2[5H]-furanone, furanone, 5,6-Dihydro-2H-pyran-2-one, 3,6-dihydro-2H-Pyran-2-one, 1H-pyrrol-2(5H)-one, 1,3-Dihydro-2H-pyrrol-2-one, 5,6-Dihydro-2(1H)-pyridinone, 3,6-Dihydro-2(1H)-pyridinone, 3,4-Dihydro-2(1H)-pyridinone, 1,5,6,7-Tetrahydro-2H-azepin-2-one, 1,3,4,5-Tetrahydro-2H-azepin-2-one, itaconic anhydride, Maleimide, 6-Hydroxypyridin-2(3H)-one, Oxirene, 2H-oxete, 2,5-Dihydrofuran, dihydrofuran, 3,4-Dihydro-2H-pyran, 3,6-Dihydro-2H-pyran, 2,3,4,5-Tetrahydrooxepine and 2,3,6,7-Tetrahydrooxepine, Thiophene-2,5-dione, 2(5H)-Thiophenone, 2(3H)-Thiophenone and 3,6-Dihydro-2H-thiopyran-2-one, preferably Maleic anhydride and at least one ring opening agent selected from the group consisting of 3-amino-1,2,4-triazole, diphenyl guanidine, 1-phenyl-1,2-ethanediol, 3-amino-1,2,4-triazole, 5-amino-1,2,4-triazole, 4-amino-1,2,3-triazole, 5-amino-1,2,3-triazole, 5-aminotetrazole, 3-aminopyrazole, 4-aminopyrazole, 5-aminopyrazole, 3-amino-5-thiol-1,2,4-triazole, urea, Diethylene triamine (DETA), melamine, cyclodextrin, 2-hydrazino-4-(trifluoromethyl)pyridimine, PEG-6000, 1-phenyl-ethane-1,2-diol, L-Alanine benzyl ester p-toluenesulfonate salt, L-Cysteine ethyl ester hydrochloride, L-Methionine ethyl ester hydrochloride, L-Phenylalanine methyl ester hydrochloride and N-(3-indolylacetyl)-L-alanine, preferably 3-amino-1,2,4-triazole, at least one rubber selected from the group consisting of natural rubber, styrene-butadiene rubber, polybutadiene, cis-1,4-polyisoprene, acrylonitrile-butadiene copolymers, EPDM rubber, butyl rubber and polychloroprene rubber.
b. optionally, at least one filler selected from the group consisting of carbon black, silica and nanoclay.

41-47. (canceled)
